(19) United States
(12) Patent Application Publication
(10) Pub. No.: US 2026/0074770 A1
(43) Pub. Date: Mar. 12, 2026

(54) TWO-SIDED ADAPTIVE BEAM WEIGHT DETERMINATION

(71) Applicant: QUALCOMM Incorporated, San Diego, CA (US)

(72) Inventors: Vasanthan RAGHAVAN, West Windsor Township, NJ (US); Yan ZHOU, San Diego, CA (US)

(21) Appl. No.: 18/882,657

(22) Filed: Sep. 11, 2024

(51) Int. Cl. H04B 7/06; H04W 24/08

(52) U.S. Cl. CPC H04B 7/06952; H04W 24/08

(57) ABSTRACT

Certain aspects of the present disclosure provide techniques for user equipment (UE)-based two-sided adaptive beam weight determination. An example method, performed at a user equipment (UE), generally includes measuring reference signals (RSs) associated with a set of beams, calculating, based on the measuring, first coefficients for combining a first subset of the set of beams to form a first adaptive beam, transmitting information regarding 1) the first coefficients, and 2) one or more identifier (IDs) associated with the first subset of beams, and processing, after transmitting the information, at least one transmission in accordance with the first adaptive beam.

### FIELD OF THE DISCLOSURE

Aspects of the present disclosure relate to wireless communications, and more particularly, to techniques for two-sided adaptive beam weight determination, for example, for use with analog/radio frequency (RF) domain beamforming.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes measuring reference signals (RSs) associated with a set of beams; calculating, based on the measuring, a first set of coefficients for combining a first subset of the set of beams to form a first adaptive beam; transmitting information regarding 1) the first set of coefficients, and 2) one or more identifier (IDs) associated with the first subset of beams; and processing, after transmitting the information, at least one transmission in accordance with the first adaptive beam.

Another aspect provides a method for wireless communications at a network entity. The method includes transmitting reference signals (RSS) associated with a set of beams; receiving, from a user equipment (UE), information regarding 1) a first set of coefficients for combining a first subset of the set of beams to form a first adaptive beam, and 2) one or more identifier (IDs) associated with the first subset of beams; and processing, after receiving the information, at least one communications in accordance with the first adaptive beam.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a call flow diagram illustrating an example of codebook based UL transmission.

FIG. 6 depicts a call flow diagram illustrating an example of non-codebook based UL transmission.

FIG. 7 depicts a call flow diagram illustrating UE-based two-sided adaptive beam weight determination, in accordance with certain aspects of the present disclosure.

FIG. 8 depicts a diagram illustrating UE-based two-sided adaptive beam weight determination, in accordance with certain aspects of the present disclosure.

FIG. 9 depicts a method for wireless communications.

FIG. 10 depicts a method for wireless communications.

FIG. 11 depicts aspects of an example communications device.

### DETAILED DESCRIPTION

Aspects of the present disclosure provide apparatuses, methods, processing systems, and computer-readable mediums for adaptive beam weight determination. As will be described in greater detail below, the disclosure proposes techniques for UE-based two-sided adaptive beam weight determination.

Beamforming is a technique that uses multiple antennas to control the direction of a radio signal, focusing energy towards the intended user(s) rather than broadcasting signals in all directions. Beamforming can also involve the use of beam weights that produce a co-phasing of the signal energy over intended directions and minimizing interference over unintended directions. This approach improves signal quality, increases data rates, reduces interference, and extends the coverage range by dynamically adjusting the signal path to the optimal direction, even as the user or device moves.

Beam management encompasses the procedures and technologies that facilitate effective beamforming, including beam selection, beam tracking, and beam switching. Beam selection involves identifying the best beam or set of beams for communication based on signal strength, quality, or other criteria. Beam tracking maintains a strong connection by continuously adjusting the beam direction to follow the user or compensate for changes in the environment, such as obstacles or movement. Beam switching enables the system to change beams when the current beam becomes suboptimal, ensuring consistent and reliable connectivity. Together, beamforming and beam management may be considered pivotal in optimizing the performance (e.g., maximizing signal strength and coverage) and efficiency of wireless networks.

Beam weights generally refer to complex coefficients applied to the signals (e.g., phase shifter and amplitude control settings) transmitted or received by each antenna element in an antenna array, used to control the direction and shape of the beam in beamforming systems. These weights adjust the phase and amplitude of the signals at each antenna to constructively combine in the desired direction and destructively interfere in other directions, thereby steering the beam towards a specific user or target area. By carefully calculating and applying beam weights, systems can enhance signal strength and reduce interference, which improves the overall communication quality and efficiency. In adaptive beamforming, beam weights are dynamically adjusted based on real-time measurements, such as channel conditions or signal feedback or hardware impairments as observed in operating conditions, to continuously optimize performance, while in fixed or codebook-based beamforming, pre-defined beam weights (e.g., that are stored in a codebook in the radio frequency integrated chip [RFIC] memory) are used according to a predetermined set of beam patterns.

At a user equipment (UE), adaptive or dynamic beam weights may be used in hybrid beamforming systems to address co-phasing of energy across multiple independent clusters within a channel or across a cluster with a wide angular spread. In this context, hybrid beamforming generally refers to a mechanism that combines analog and digital beamformers (e.g., to balance hardware costs and transmission performance). Adaptive/dynamic beam weights may also help to mitigate UE housing-induced mismatches and imbalances across polarizations, as well as blockage distortions in energy fields across polarizations. Adaptive beam weights can be learned/determined based on synchronization signal blocks (SSBs) or other reference signals (RSs) transmitted to the UE by the network (e.g., a gNB). They represent a “non-codebook” approach to beamforming, in contrast to “codebook-based” beamforming systems where direction-specific energy steering beam weights are pre-designed (e.g., a priori) and stored in RFIC chip memory.

The key difference between “codebook-based” beamforming and adaptive beam weights lies in their operational protocols. In “codebook-based” beamforming, a certain (e.g., predefined) set of beam weights is used at the UE side. The UE may estimate the RSRP or signal strength, and if it is satisfactory, the UE may use the corresponding beam weight for transmission and reception (e.g., with adjustments for uplink/downlink calibration), aligning with a “what-you-see-is-what-you-get” approach (e.g., measured and used beam weights are the same). Conversely, adaptive beamforming uses “sampling beams” initially to estimate the Channel Impulse Response (CIR), from which it constructs (e.g., based on measurements associated with the sampling beams) a set of adaptive beam weights for subsequent transmission and reception. However, since the sampling beams differ from the final adaptive beam weights, there is a potential for mismatches between the measurements and their practical usage.

Aspects of the present disclosure provide techniques (e.g., uplink and downlink procedures) for two-sided (e.g., UE and network side) adaptive beam weight determination/estimation. Two-sided adaptive beam weight determination/estimation may improve the performance and efficiency of wireless networks, positively impact beam failure detection (BFD), and may help to minimize the gap associated with singular value decomposition (SVD) performance.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

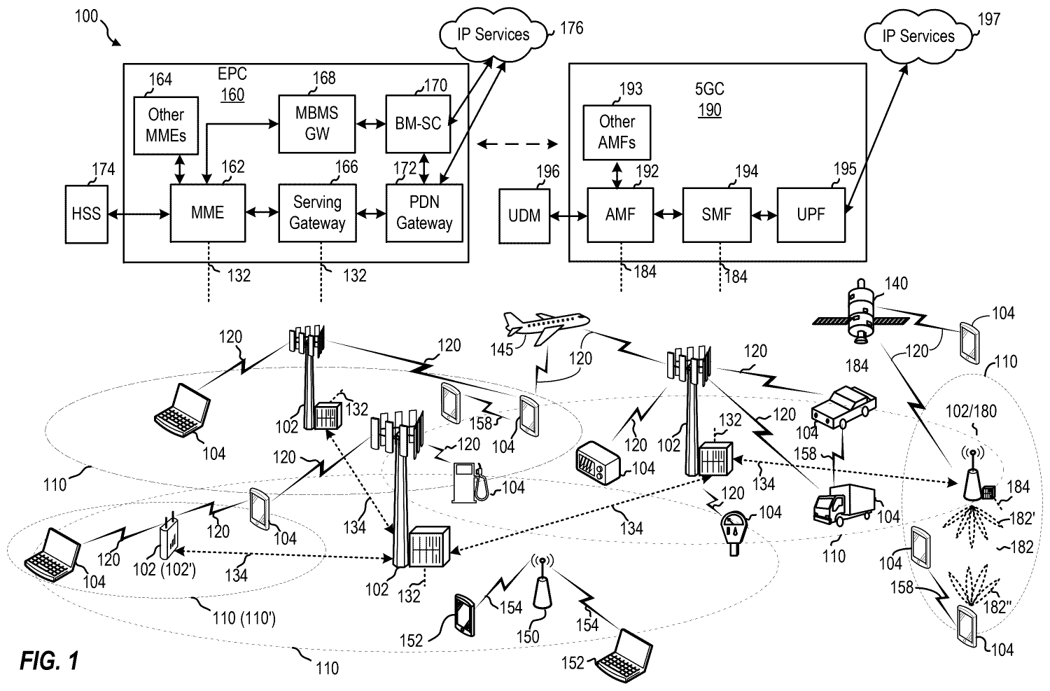

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

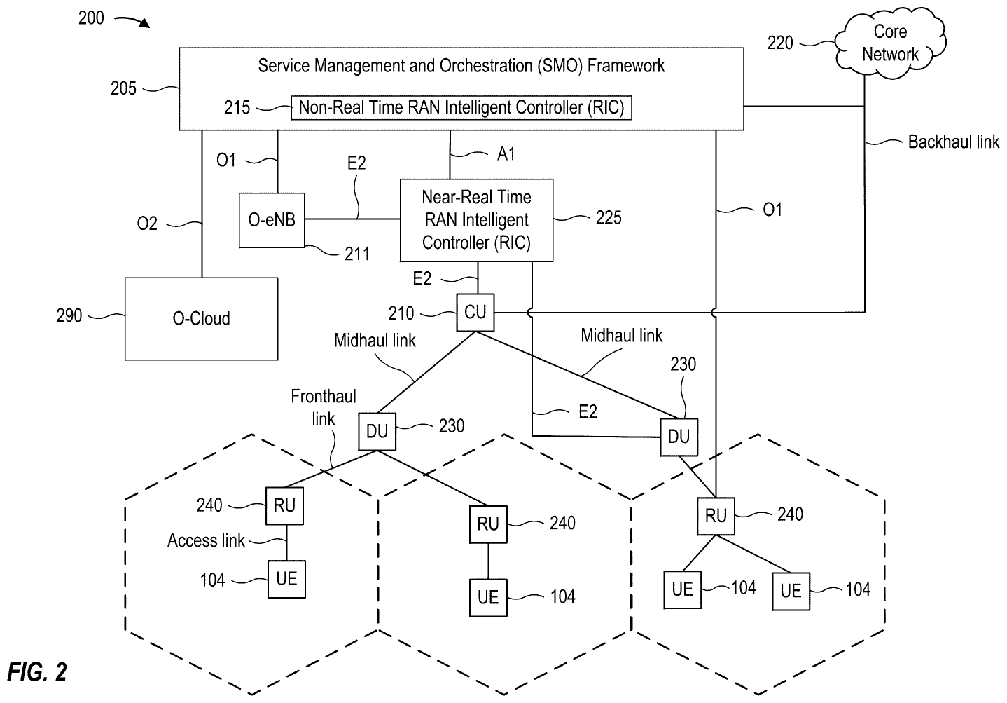

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

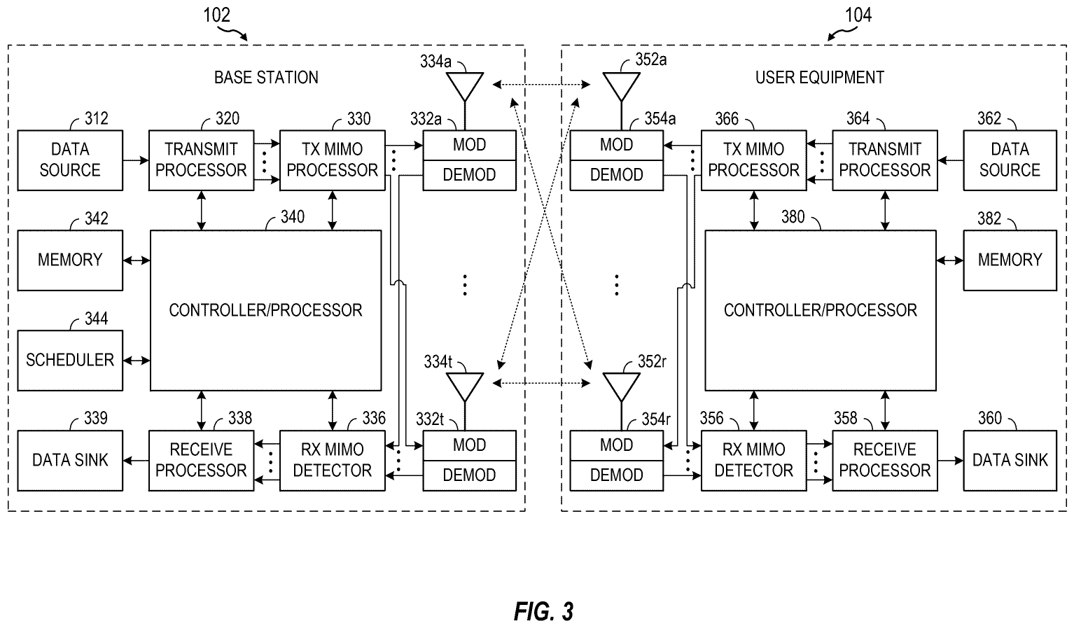

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

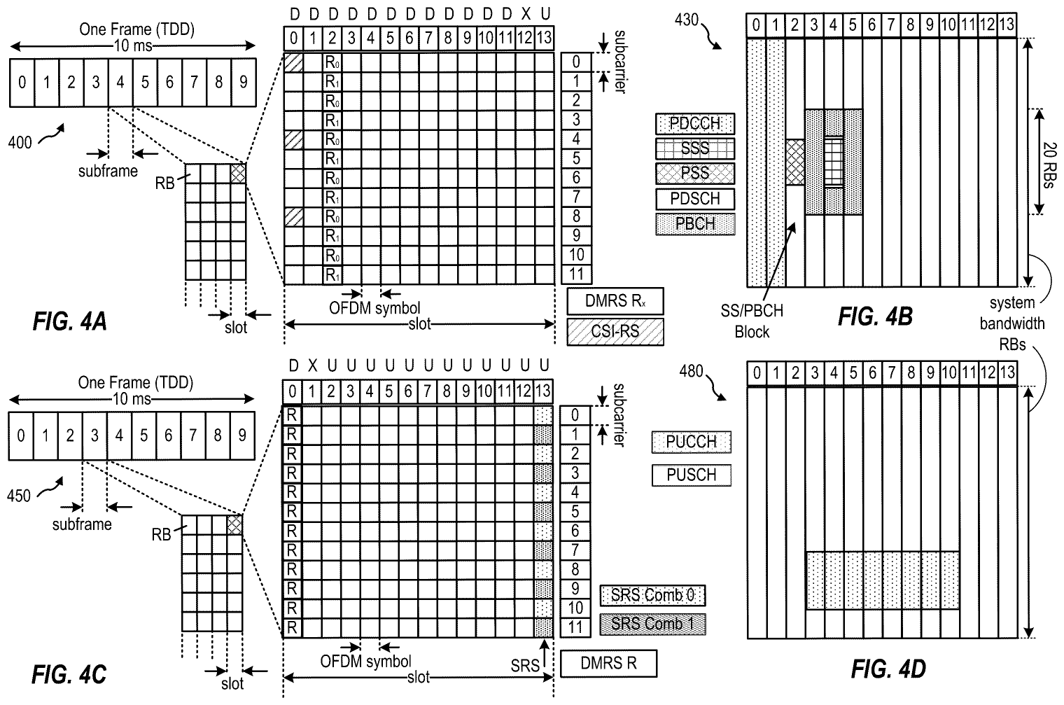

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### QCL Ports and TCI States

In many cases, it is important for a UE to know which assumptions it can make on a channel corresponding to different transmissions. For example, the UE may need to know which reference signals (RSs) it can use to estimate the channel in order to decode a transmitted signal (e.g., PDCCH or PDSCH). It may also be important for the UE to be able to report relevant channel state information (CSI) to the BS (e.g., a gNB) for scheduling, link adaptation, and/or beam management purposes. In NR, the concept of quasi co-location (QCL) and transmission configuration indicator (TCI) states is used to convey information about these assumptions.

QCL assumptions are generally defined in terms of channel properties. Per 3GPP TS 38.214, “two antenna ports are said to be quasi-co-located if properties of the channel over which a symbol on one antenna port is conveyed can be inferred from the channel over which a symbol on the other antenna port is conveyed.” Different reference signals may be considered quasi co-located (“QCL′d”) if a receiver (e.g., a UE) can apply channel properties determined by detecting a first reference signal to help detect a second reference signal. TCI states generally include configurations such as QCL-relationships, for example, between the DL RSs in one CSI-RS set and the PDSCH DMRS ports.

In some cases, a UE may be configured with up to M TCI-States. Configuration of the M TCI-States can come about via higher layer signaling, while a UE may be signaled to decode PDSCH according to a detected PDCCH with DCI indicating one of the TCI states. Each configured TCI state may include one RS set TCI-RS-SetConfig that indicates different QCL assumptions between certain source and target signals.

For example, TCI-RS-SetConfig may indicate a source RS in the top block and may be associated with a target signal indicated in the bottom block. In this context, a target signal generally refers to a signal for which channel properties may be inferred by measuring those channel properties for an associated source signal. As noted above, a UE may use the source RS to determine various channel parameters, depending on the associated QCL type, and use those various channel properties (determined based on the source RS) to process the target signal. A target RS does not necessarily need to be a PDSCH's DMRS. In some cases, for example, a target RS may be any other RS (e.g., PUSCH DMRS, CSIRS, TRS, and SRS).

Each TCI-RS-SetConfig may contain various parameters. These parameters can, for example, configure quasi co-location relationship(s) between reference signals in the RS set and the DM-RS port group of the PDSCH. The RS set contains a reference to either one or two DL RSs and an associated quasi co-location type (QCL-Type) for each one configured by the higher layer parameter QCL-Type.

For the case of two DL RSs, the QCL types can take on a variety of arrangements. For example, QCL types may not be the same, regardless of whether the references are to the same DL RS or different DL RSs. In the illustrated example, SSB is associated with Type C QCL for P-TRS, while CSI-RS for beam management (CSIRS-BM) is associated with Type D QCL.

QCL information and/or types may in some scenarios depend on or be a function of other information. For example, the quasi co-location (QCL) types indicated to the UE can be based on higher layer parameter QCL-Type and may take one or a combination of the following types:

QCL-TypeA: {Doppler shift, Doppler spread, average delay, delay
spread},
QCL-TypeB: {Doppler shift, Doppler spread},
QCL-TypeC: {average delay, Doppler shift}, and
QCL-TypeD: {Spatial Rx parameter},

Spatial QCL assumptions (QCL-TypeD) may be used to help a UE to select an analog Rx beam (e.g., during beam management procedures). For example, an SSB resource indicator may indicate a same beam for a previous reference signal should be used for a subsequent transmission.

An initial ControlResourceSet CORESET (e.g., CORESET ID 0 or simply CORESET #0) in NR may be identified during initial access by a UE (e.g., via a field in the MIB). A ControlResourceSet information element (CORESET IE) sent via radio resource control (RRC) signaling may convey information regarding a CORESET configured for a UE. The CORESET IE generally includes a CORESET ID, an indication of frequency domain resources (e.g., a number of RBs) assigned to the CORESET, contiguous time duration of the CORESET in a number of symbols, and Transmission Configuration Indicator (TCI) states.

As noted above, a subset of the TCI states provide QCL relationships between DL RS(s) in one RS set (e.g., TCI-Set) and PDCCH demodulation RS (DMRS) ports. A particular TCI state for a given UE (e.g., for unicast PDCCH) may be conveyed to the UE by the Medium Access Control (MAC) Control Element (MAC-CE). The particular TCI state is generally selected from the set of TCI states conveyed by the CORESET IE, with the initial CORESET (CORESET #0) generally configured via MIB.

Search space information may also be provided via RRC signaling. For example, the SearchSpace IE is another RRC IE that defines how and where to search for PDCCH candidates for a given CORESET. Each search space is associated with one CORESET. The SearchSpace IE identifies a search space configured for a CORESET by a search space ID. In some aspects, the search space ID associated with CORESET #0 is SearchSpace ID #0. The search space is generally configured via PBCH (MIB).

### Example Codebook/Non-Codebook Based Transmissions

Some deployments (e.g., NR Release 15 and 16 systems) support codebook-based transmission and non-codebook-based transmission schemes for uplink transmissions with wideband precoders. Codebook-based UL transmission is based on BS configuration and can be used in cases where reciprocity may not hold.

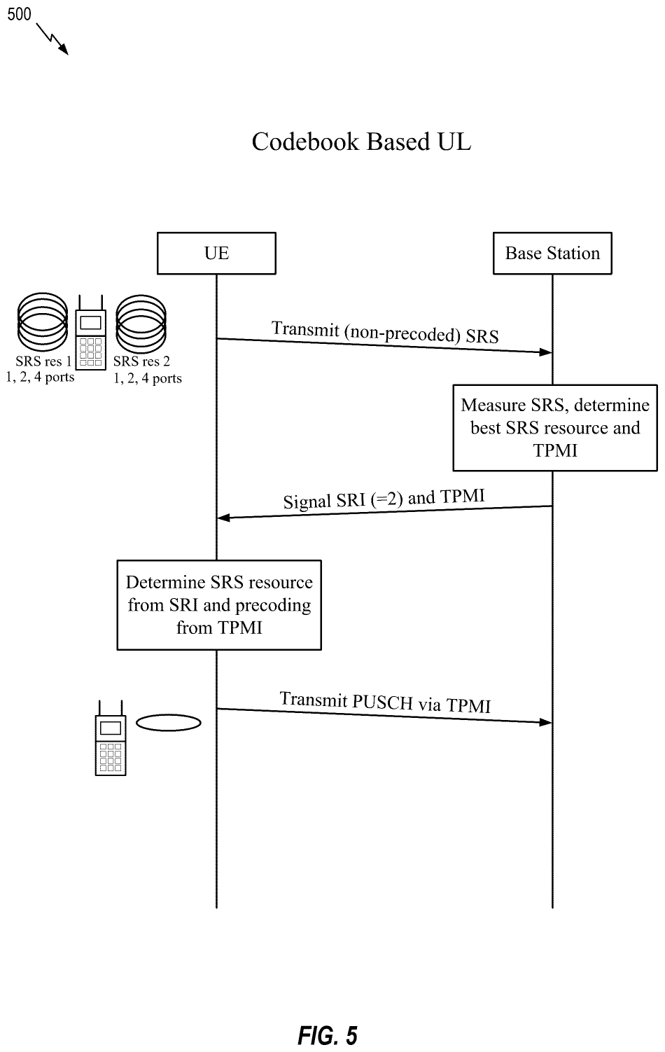

FIG. 5 is a call flow diagram 500 illustrating an example of conventional codebook based UL transmission using a wideband precoder. As illustrated, a UE transmits (non-precoded) SRS with up to 2 SRS resources (with each resource having 1, 2 or 4 ports). The gNB measures the SRS and, based on the measurement, selects one SRS resource and a wideband precoder to be applied to the SRS ports within the selected resource.

As illustrated, the gNB configures the UE with the selected SRS resource via an SRS resource indictor (SRI) and with the wideband precoder via a transmit precoder matrix indicator (TPMI). For a dynamic grant, the SRI and TPMI may be configured via DCI format 0_1. For a configured grant (e.g., for semi-persistent uplink), SRI and TPMI may be configured via RRC or DCI.

The UE determines the selected SRS resource from the SRI and precoding from TPMI and transmits PUSCH accordingly.

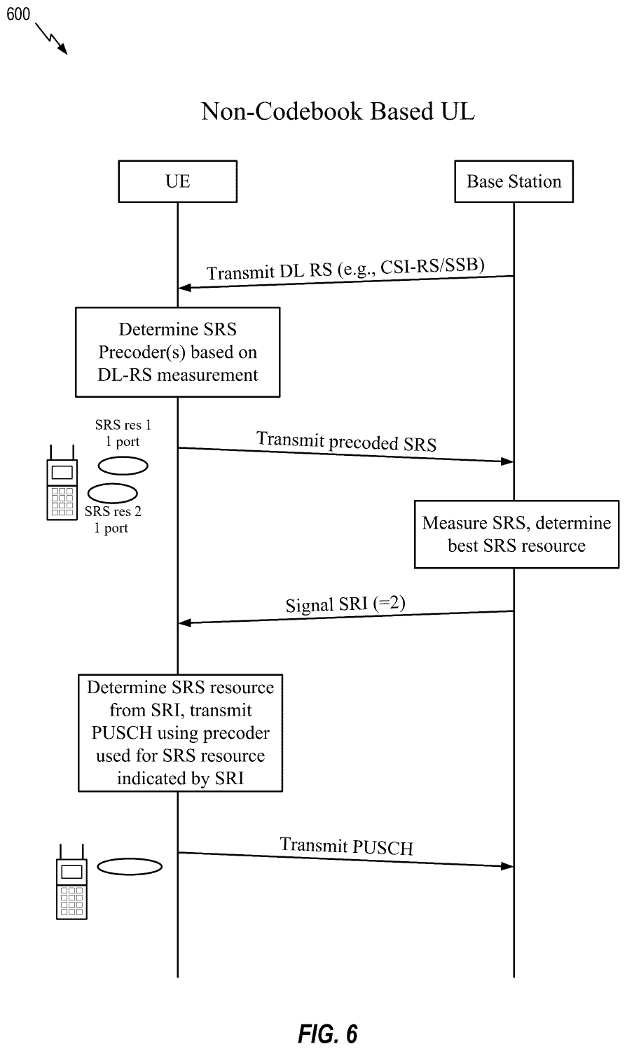

FIG. 6 is a call flow diagram 600 illustrating an example of non-codebook based UL transmission. As illustrated, a UE transmits (precoded) SRS. While the example shows 2 SRS resources, the UE may transmit with up to 4 SRS resources (with each resource having 1 port). The gNB measures the SRS and, based on the measurement, selects one or more SRS resource. In this case, since the UE sent the SRS precoded, by selecting the SRS resource, the gNB is effectively also selecting precoding. For non-codebook based UL transmission, each SRS resource corresponds to a layer. The precoder of the layer is actually the precoder of the SRS which is emulated by the UE. Selecting N SRS resources means the rank is N. The UE is to transmit PUSCH using the same precoder as the SRS.

As illustrated, the gNB configures the UE with the selected SRS resource via an SRS resource indictor (SRI). For a dynamic grant, the SRI may be configured via DCI format 0_1. For a configured grant, the SRI may be configured via RRC or DCI.

### Aspects Related to UE-Based Two-Sided Adaptive Beam Weight Determination

As noted above, since sampling beams differ from the final adaptive beam weights, there is a potential for mismatches between measurements and their practical usage. Aspects of the present disclosure provide techniques (e.g., uplink and downlink procedures) for what may be referred to as a two-sided adaptive beam weight determination/estimation (e.g., referring to involvement at both the UE and network sides).

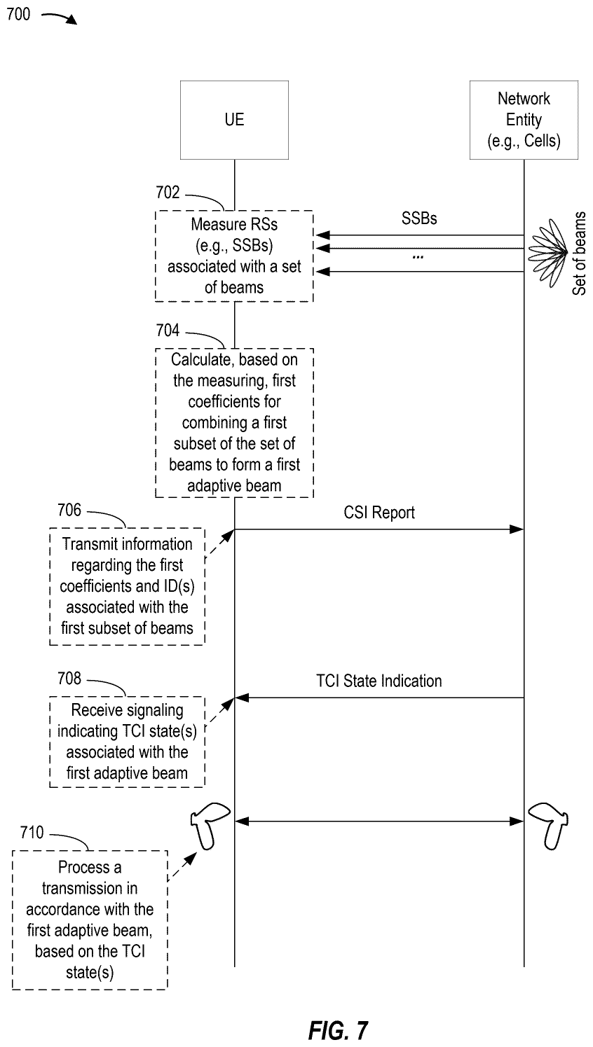

These techniques may be understood with reference to FIG. 7, which depicts a call flow diagram 700 illustrating UE-based two-sided adaptive beam weight determination, in accordance with certain aspects of the present disclosure. In some aspects, the network entity may be an example of the BS 102 depicted and described with respect to FIGS. 1 and 3 or a disaggregated base station depicted and described with respect to FIG. 2. In some aspects, the network entity may be a an example of a base station 102 depicted and described with respect to FIGS. 1 and 3. In some aspects, the network entity may be an example of a distributed unit (DU), which may be managing/communicating with multiple radio units (RUS) (e.g., associated with multiple cells). Similarly, the UE may be an example of UE 104 depicted and described with respect to FIGS. 1 and 3. However, in other aspects, the UE may be another type of wireless communications device and the network entity may be another type of network entity or network node, such as those described herein.

As illustrated at 702, the UE may measure RSs (e.g., SSBs) associated with a set of beams. For example, each RS may be transmitted using a different beam. In some cases, the UE may be configured with RS resources for such measurement.

As illustrated at 704, the UE may calculate, based on the measuring, a first set of coefficients for combining a first subset of the set of beams to form a first adaptive beam. Similarly, the UE may also calculate, based on the measuring, a second set of coefficients for combining a second subset of the set of beams to form a second adaptive beam.

As illustrated at 706, the UE may transmit information regarding the first (e.g., and the second) set of coefficients and IDs associated with the first (e.g., and the second) subset(s) of beams.

As illustrated at 708, the UE may receive signaling (e.g., a MAC-CE or DCI) indicating transmission configuration indicator (TCI) state(s) associated with the first adaptive beam (e.g., and/or the second adaptive beam).

As illustrated at 710, the UE may process (e.g., transmit or receive) a communications in accordance with the first adaptive beam (e.g., and/or the second adaptive beam), based on the TCI state(s).

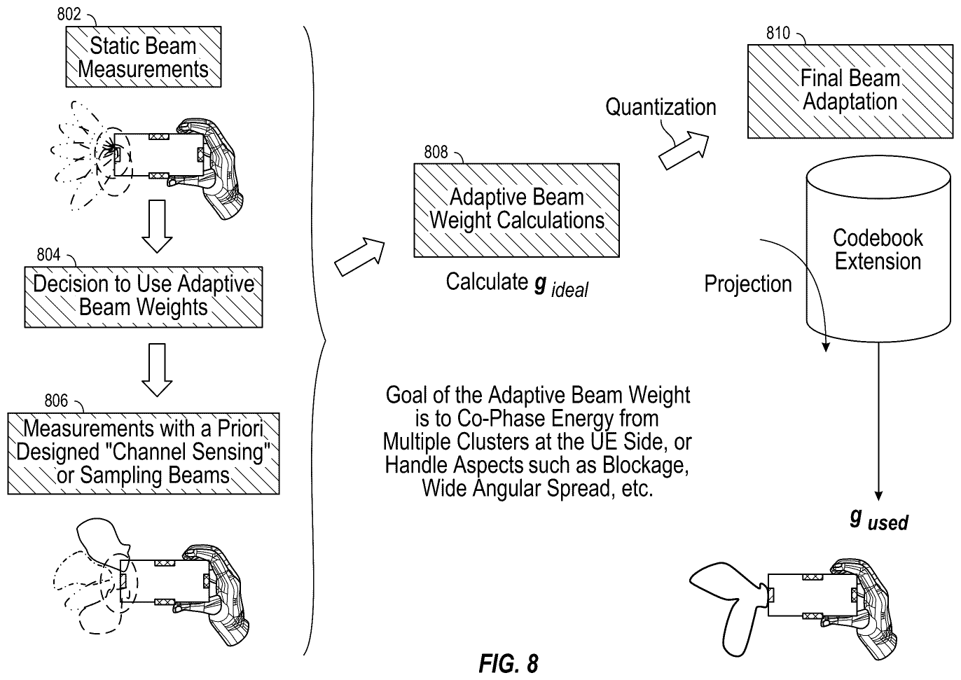

FIG. 8 depicts a diagram 800 illustrating an example of UE-based two-sided adaptive beam weight determination, in accordance with certain aspects of the present disclosure.

As illustrated at 802, a UE may measure RSs (e.g., SSBs) associated with a set of static (e.g., non-adaptive/non-dynamic) beams. As illustrated at 804, the UE may decide (e.g., or be configured to) use adaptive beams/adaptive beam weights (e.g., based on the measurements of the static beams). As illustrated at 806, the UE may measure RSs (e.g., SSBs) associated with a set of pre-designed sampling/channel sensing beams (e.g., having adaptive/dynamic beam weights)

As illustrated at 808, these measurements 802 and/or 806 may be used to calculate adaptive beam weights (e.g., g_{ideal}), which may be quantized, resulting in final beam adaptation 810. As illustrated, the final beam adaptation may be projected on/included in an extended codebook, and the final, actual adaptive beam weights (e.g., g_{used}) may be used to process (e.g., receive or transmit) one or more communications.

Aspects of the present disclosure provide various techniques/procedures for UE-based two-sided DL adaptive beam weight determination.

In some aspects (e.g., according to a first step), a UE may identify (e.g., the most optimal) K (e.g., K≥2) downlink reference signal (DL RS) receive (RX) beams (e.g., SSB RX beams) to be combined to form one or more adaptive/dynamic beams. These beams may be denoted as (e.g., represented by) g_{SSB1}, g_{SSB2}, . . . , g_{SSBK}, each of which is associated with an SSB TX beam, where the SSB TX beams may be denoted as (e.g., represented by) f_{SSB1}, f_{SSB2}, . . . , f_{SSBK}. The beam selection could be based on L1-SINR, L1-RSRP, or more advanced metrics (based on CQI or spectral efficiency).

In some aspects (e.g., according to a second step), a UE may identify combining coefficients for the associated SSB TX beams (f_{SSB1}+α₁f_{SSB2}+ . . . +α_{K-1}f_{SSBK}).

In some aspects (e.g., according to a third step), a UE may signal/indicate (e.g., provide feedback including) the combining coefficients and corresponding SSB IDs (e.g., which may be referred to and/or signaled as one adaptive beam ID for beam selection). In some cases, this adaptive beam ID may have no dependence on the digital precoder and layers used in later communications. These techniques differ from certain Type-2 codebook techniques that are already prespecified in Third Generation Partnership Project (3GPP) technical specifications, in that the combined beam may not be used for layer mapping, precoding matrix indicator (PMI) determination, and may carry multiple layers with its own PMI (e.g., 2 layers for the combined adaptive beam weight with 2 polarizations).

In some aspects (e.g., according to a fourth step), the network (e.g., a gNB) may use transmission configuration indicator (TCI) state(s) according to at least one of Option 1 or Option 2, described below.

According to a first option (Option 1), a gNB may use a new configured TCI state, which has the CSI-RS for beam management (BM) transmitted in accordance with (e.g., using) the DL adaptive beam weight.

According to a second option (Option 2), a gNB may use a virtual TCI state index mapped to one or more existing configured TCI state(s), in accordance with (e.g., using) the DL adaptive beam weight combination. For example, virtual TCI ID=1 may mean that it is formed by configured TCI ID=7 and configured TCI ID 20 corresponding to SSB 7 and SSB 20, with a particular set of combining coefficients (e.g., combining coefficient set 1). Signaling and use of the adaptive beam indication could be similar to other unified TCI frameworks (e.g., a downlink unified TCI framework).

In some aspects (e.g., according to a fifth step), the UE and/or the gNB may determine CSI parameters for the downlink adaptive beam weights. For example, existing CSI feedback frameworks may be used to determine certain information (e.g., rank, PMI, modulation and coding scheme (MCS), and/or channel quality indicator (CQI)).

In some aspects, in scenarios involving inter-cell multiple TRP (mTRP) and/or beam management (BM), a UE may consider SSB beams from different cells when determining adaptive beams. In such cases, for example, a UE may consider two SSB RX beams from (associated with) different cells or Physical Cell Identities (PCIs).

In mTRP scenarios, a UE may consider two SSBs and/or CSI-RSs associated with TCIs mapped to different TRP IDs. For example, in multi-DCI mTRP, each CORESET may have its own indicated TCI and CORESET pool index, based on which the UE may figure out mappings between each combined beam or DL RS (e.g., SSB or CSI-RS in TCI) and TRP(s) or CORESET pool index(es).

In some aspects, for quantization (e.g., similarly to Type-2 codebook techniques), a UE may feedback/signal the combined beam IDs (e.g., SSB ID or CSI-RS ID), instead of the horizontal/vertical directions associated with the adaptive beam. A UE may also feedback/signal the combining coefficients for those beam IDs, and/or the combining coefficient(s) for cross-polarization (X-pol).

In some cases, a UE may perform DL beam failure detection (BFD) based on the DL adaptive beam (associated with the DL adaptive beam weights). In some aspects, in addition to Step 4 described above (e.g., a gNB using transmission configuration indicator (TCI) state(s) according to Option 1 or Option 2, described above), one DL RS transmitted in accordance with (e.g., using) the DL adaptive beam weights may be assigned for DL BFD. This DL RS may be explicitly configured or implicitly determined as one QCL source RS in the DL adaptive beam weight TCI state. One advantage of this approach is that it is similar to existing BFD RS determination techniques. However, separate RSs may be needed for each DL adaptive beam, which cannot be shared by other UEs. Thus, this approach may result in increased overhead.

In some aspects, in addition to Step 4 described above (e.g., a gNB using transmission configuration indicator (TCI) state(s) according to Option 1 or Option 2, described above), existing configured DL RSs may be reused, forming the DL adaptive beam weights for DL BFD. One advantage of this approach is that the two DL RSs can be shared by other UEs without additional overhead.

As noted above, DL RS may be explicitly configured or implicitly determined. In the case of explicit configuration, the two DL RSs and combining coefficient may be explicitly signaled to UE. The UE may then combine the two RSs and use the combined reference signal received power (RSRP), signal-to-interference-and-noise ratio (SINR), and/or signal to noise ratio (SNR), to determine/detect beam failure for that DL adaptive beam weight.

In the case of implicit BFD RS determination, the UE may use two QCL source RSs in two existing TCIs and the corresponding combining coefficient associated with a virtual TCI for the combined metric computation.

Aspects of the present disclosure provide techniques/procedures for UE-based two-sided uplink (UL) adaptive beam weight determination.

In some aspects (according to a first alternative or “Alt 1”), the same DL adaptive beam weight(s) may be used for UL, for the same set of combined SSBs. This approach may be imperfect, however, since each SSB beam may have a different power backoff in UL, and thus, the best beam sets and combining coefficients for the UL adaptive beam could be different from those used for the DL adaptive beam.

In some aspects (according to a second alternative or “Alt 2”), separate UL adaptive beam weights (e.g., different from the DL adaptive beam weights) may be used, even for the same set of combined SSBs. In such cases, the best UL combined beam sets may be based on each UL SSB beam's UL RSRP, considering the maximum allowed TX power for each UL beam. The corresponding UL beam combining coefficients may be based on the UL RSRP.

In some aspects, as described below, the techniques/procedures for UE-based two-sided uplink (UL) adaptive beam weight determination may vary depending on whether Alt 1 or Alt 2 is used.

In some aspects (e.g., according to a first step), a UE may identify two (e.g., most optimal) SSB RX beams to be combined in UL. In some aspects (e.g., according to a second step), a UE may also identify the combining coefficients for the SSB UL beams.

In some aspects (e.g., according to a third step), a UE may signal/feedback information for the UL adaptive beam weights in a manner similar to the feedback described above for DL. For example, a UE may signal/indicate (e.g., provide feedback including) the combining coefficients and corresponding SSB IDs (e.g., which may be referred to and/or signaled as one adaptive beam ID for beam selection). In addition, the relation between UL and DL adaptive beam weights feedback may depend on whether Alt 1 or Alt 2 is used. For example, in the case of Alt 1 (where the same adaptive beam weights are used for DL and UL), the same feedback may be provided for both DL and UL. In the case of Alt 2 (where different adaptive beam weights are used for DL and UL), separate/different feedback may be provided for UL and DL.

In some aspects (e.g., according to a fourth step), beam indication may be based on transmission configuration indicator (TCI) state(s) for UL adaptive beam weights, similarly to Option 1 or Option 2, described above. For example, a gNB may use a new configured TCI state, where transmission is in accordance with the UL adaptive beam weight(s) or a virtual TCI state index mapped to one or more existing configured TCI state(s), in accordance the UL adaptive beam weight combination. In addition, on the relation between UL and DL configured TCI for adaptive beam weights may vary based on whether Alt 1 or Alt 2 is used. For example, in the case of Alt 1 (where the same adaptive beam weights are used for DL and UL), the same DL adaptive beam weight TCI may also be applied to UL. In the case of Alt 2 (where different adaptive beam weights are used for DL and UL), separate UL adaptive beam weight TCI may applied to UL (different from the DL adaptive beam weight TCI).

In some aspects (e.g., according to a fifth step), UL MIMO parameters may be determined for the UL adaptive beam weight. For example, existing UL sounding may be reused to determine certain UL MIMO parameters (e.g., rank, transmitted PMI (TPMI), and/or MCS).

The techniques disclosed herein for two-sided adaptive beam weight determination/estimation may improve the performance and efficiency of wireless networks, positively impact BFD, and may help to minimize the gap associated with singular value decomposition (SVD) performance.

### Example Operations

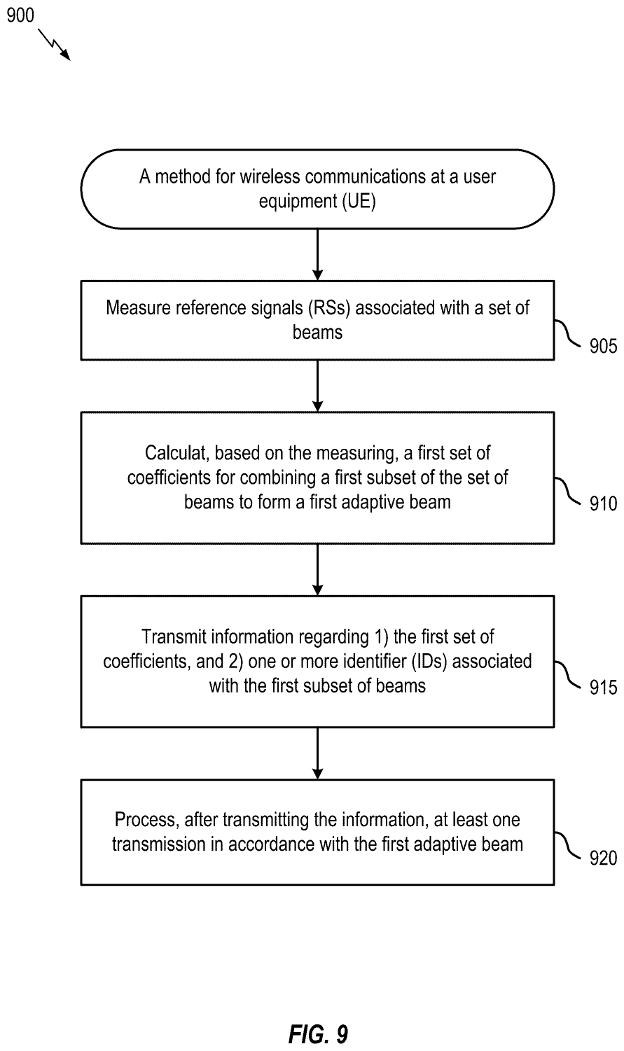

FIG. 9 shows an example of a method 900 of wireless communications at a user equipment (UE), such as a UE 104 of FIGS. 1 and 3.

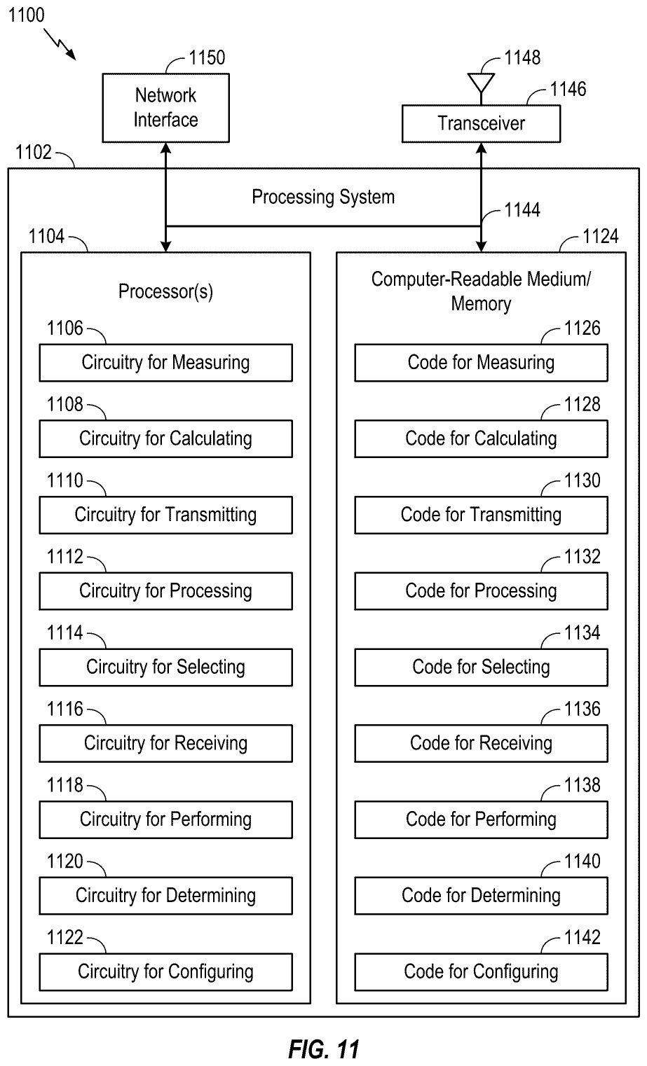

Method 900 begins at step 905 with measuring reference signals (RSs) associated with a set of beams. In some cases, the operations of this step refer to, or may be performed by, circuitry for measuring and/or code for measuring as described with reference to FIG. 11.

Method 900 then proceeds to step 910 with calculating, based on the measuring, first coefficients for combining a first subset of the set of beams to form a first adaptive beam. In some cases, the operations of this step refer to, or may be performed by, circuitry for calculating and/or code for calculating as described with reference to FIG. 11.

Method 900 then proceeds to step 915 with transmitting information regarding 1) the first coefficients, and 2) one or more identifier (IDs) associated with the first subset of beams. In some cases, the operations of this step refer to, or may be performed by, circuitry for transmitting and/or code for transmitting as described with reference to FIG. 11.

Method 900 then proceeds to step 920 with processing, after transmitting the information, at least one transmission in accordance with the first adaptive beam. In some cases, the operations of this step refer to, or may be performed by, circuitry for processing and/or code for processing as described with reference to FIG. 11.

In some aspects, the one or more IDs comprise synchronization signal block (SSB) IDs.

In some aspects, the method 900 further includes selecting the first subset of beams based on the measuring. In some cases, the operations of this step refer to, or may be performed by, circuitry for selecting and/or code for selecting as described with reference to FIG. 11.

In some aspects, the measuring comprises measuring at least one of signal to interference and noise ratio (SINR) or reference signal received power (RSRP).

In some aspects, the measuring comprises measuring RSs from at least two different cells; and the first subset of beams comprises at least one beam from each of the at least two different cells.

In some aspects, the method 900 further includes receiving signaling indicating at least one transmission configuration indicator (TCI) state associated with the first adaptive beam, wherein the processing is based on the TCI state. In some cases, the operations of this step refer to, or may be performed by, circuitry for receiving and/or code for receiving as described with reference to FIG. 11.

In some aspects, the at least one TCI state comprises: a configured TCI state associated with adaptive beam weights; or a virtual TCI state with an index mapped to configured TCI states.

In some aspects, processing the at least one transmission comprises receiving a downlink transmission in accordance with the first adaptive beam.

In some aspects, the method 900 further includes performing beam failure detection (BFD) based on the downlink transmission received in accordance with the first adaptive beam. In some cases, the operations of this step refer to, or may be performed by, circuitry for performing and/or code for performing as described with reference to FIG. 11.

In some aspects, the BFD is based on a downlink (DL) RS transmitted according to the first coefficients.

In some aspects, the BFD is based on a combining, using the coefficients, of measurements of downlink (DL) RSs configured for the beams selected for the first subset.

In some aspects, the method 900 further includes determining the DL RSs to measure and combined based on: an explicit configuration, or quasi co-location (QCL) source RSs associated with configured transmission configuration indicator (TCI) states. In some cases, the operations of this step refer to, or may be performed by, circuitry for determining and/or code for determining as described with reference to FIG. 11.

In some aspects, processing the at least one transmission comprises transmitting an uplink transmission in accordance with the first adaptive beam.

In some aspects, processing the at least one transmission further comprises receiving a downlink transmission using beam weights corresponding to the first adaptive beam.

In some aspects, processing the at least one transmission further comprises receiving a downlink transmission using second coefficients corresponding to a second adaptive beam.

In some aspects, the method 900 further includes transmitting information regarding the second coefficients. In some cases, the operations of this step refer to, or may be performed by, circuitry for transmitting and/or code for transmitting as described with reference to FIG. 11.

In one aspect, method 900, or any aspect related to it, may be performed by an apparatus, such as communications device 1100 of FIG. 11, which includes various components operable, configured, or adapted to perform the method 900.

Communications device 1100 is described below in further detail.

Note that FIG. 9 is just one example of a method, and other methods including fewer, additional, or alternative steps are possible consistent with this disclosure.

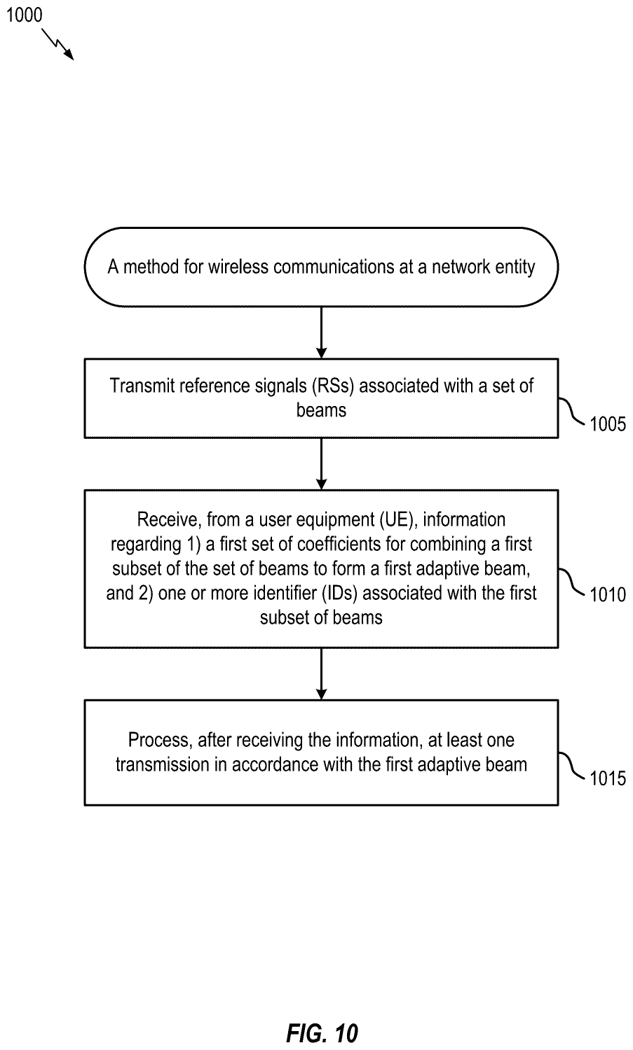

FIG. 10 shows an example of a method 1000 of wireless communications at a network entity, such as a BS 102 of FIGS. 1 and 3, or a disaggregated base station as discussed with respect to FIG. 2.

Method 1000 begins at step 1005 with transmitting reference signals (RSS) associated with a set of beams. In some cases, the operations of this step refer to, or may be performed by, circuitry for transmitting and/or code for transmitting as described with reference to FIG. 11.

Method 1000 then proceeds to step 1010 with receiving, from a user equipment (UE), information regarding 1) first coefficients for combining a first subset of the set of beams to form a first adaptive beam, and 2) one or more identifier (IDs) associated with the first subset of beams. In some cases, the operations of this step refer to, or may be performed by, circuitry for receiving and/or code for receiving as described with reference to FIG. 11.

Method 1000 then proceeds to step 1015 with processing, after receiving the information, at least one transmission in accordance with the first adaptive beam. In some cases, the operations of this step refer to, or may be performed by, circuitry for processing and/or code for processing as described with reference to FIG. 11.

In some aspects, the one or more IDs comprise synchronization signal block (SSB) IDs.

In some aspects, the RSs are transmitted from at least two different cells associated with the network entity; and the first subset of beams comprises at least one beam from each of the at least two different cells.

In some aspects, the method 1000 further includes transmitting signaling indicating at least one transmission configuration indicator (TCI) state associated with the first adaptive beam, wherein the processing is based on the TCI state. In some cases, the operations of this step refer to, or may be performed by, circuitry for transmitting and/or code for transmitting as described with reference to FIG. 11.

In some aspects, the at least one TCI state comprises: a configured TCI state associated with adaptive beam weights; or a virtual TCI state with an index mapped to configured TCI states.

In some aspects, processing the at least one transmission comprises transmitting, to the UE, a downlink transmission in accordance with the first adaptive beam.

In some aspects, the method 1000 further includes configuring the UE with downlink (DL) RSs for performing beam failure detection (BFD), wherein processing the at least one transmission comprises transmitting DL RSs in accordance with the configuration and the first adaptive beam. In some cases, the operations of this step refer to, or may be performed by, circuitry for configuring and/or code for configuring as described with reference to FIG. 11.

In some aspects, the configuration: comprises an explicit configuration, or indicates quasi co-location (QCL) source RSs associated with configured transmission configuration indicator (TCI) states.

In some aspects, processing the at least one transmission comprises receiving, from the UE, an uplink transmission in accordance with the first adaptive beam.

In some aspects, processing the at least one transmission further comprises transmitting a downlink transmission using beam weights corresponding to the first adaptive beam.

In some aspects, processing the at least one transmission further comprises transmitting a downlink transmission using second coefficients corresponding to a second adaptive beam.

In some aspects, the method 1000 further includes receiving, from the UE, information regarding the second coefficients. In some cases, the operations of this step refer to, or may be performed by, circuitry for receiving and/or code for receiving as described with reference to FIG. 11.

In one aspect, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative steps are possible consistent with this disclosure.

### Example Communications Device(s)

FIG. 11 depicts aspects of an example communications device 1100. In some aspects, communications device 1100 is a user equipment, such as UE 104 described above with respect to FIGS. 1 and 3. In some aspects, communications device 1100 is a network entity, such as BS 102 of FIGS. 1 and 3, or a disaggregated base station as discussed with respect to FIG. 2.

The communications device 1100 includes a processing system 1102 coupled to the transceiver 1146 (e.g., a transmitter and/or a receiver). In some aspects (e.g., when communications device 1100 is a network entity), processing system 1102 may be coupled to a network interface 1150 that is configured to obtain and send signals for the communications device 1100 via communication link(s), such as a backhaul link, midhaul link, and/or fronthaul link as described herein, such as with respect to FIG. 2. The transceiver 1146 is configured to transmit and receive signals for the communications device 1100 via the antenna 1148, such as the various signals as described herein. The processing system 1102 may be configured to perform processing functions for the communications device 1100, including processing signals received and/or to be transmitted by the communications device 1100.

The processing system 1102 includes one or more processors 1104. In various aspects, the one or more processors 1104 may be representative of one or more of receive processor 358, transmit processor 364, TX MIMO processor 366, and/or controller/processor 380, as described with respect to FIG. 3. In various aspects, one or more processors 1104 may be representative of one or more of receive processor 338, transmit processor 320, TX MIMO processor 330, and/or controller/processor 340, as described with respect to FIG. 3. The one or more processors 1104 are coupled to a computer-readable medium/memory 1124 via a bus 1144. In certain aspects, the computer-readable medium/memory 1124 is configured to store instructions (e.g., computer-executable code) that when executed by the one or more processors 1104, cause the one or more processors 1104 to perform the method 900 described with respect to FIG. 9, or any aspect related to it; and the method 1000 described with respect to FIG. 10, or any aspect related to it. Note that reference to a processor performing a function of communications device 1100 may include one or more processors 1104 performing that function of communications device 1100.

In the depicted example, computer-readable medium/memory 1124 stores code (e.g., executable instructions), such as code for measuring 1126, code for calculating 1128, code for transmitting 1130, code for processing 1132, code for selecting 1134, code for receiving 1136, code for performing 1138, code for determining 1140, and code for configuring 1142. Processing of the code for measuring 1126, code for calculating 1128, code for transmitting 1130, code for processing 1132, code for selecting 1134, code for receiving 1136, code for performing 1138, code for determining 1140, and code for configuring 1142 may cause the communications device 1100 to perform the method 900 described with respect to FIG. 9, or any aspect related to it; and the method 1000 described with respect to FIG. 10, or any aspect related to it.

The one or more processors 1104 include circuitry configured to implement (e.g., execute) the code stored in the computer-readable medium/memory 1124, including circuitry for measuring 1106, circuitry for calculating 1108, circuitry for transmitting 1110, circuitry for processing 1112, circuitry for selecting 1114, circuitry for receiving 1116, circuitry for performing 1118, circuitry for determining 1120, and circuitry for configuring 1122. Processing with circuitry for measuring 1106, circuitry for calculating 1108, circuitry for transmitting 1110, circuitry for processing 1112, circuitry for selecting 1114, circuitry for receiving 1116, circuitry for performing 1118, circuitry for determining 1120, and circuitry for configuring 1122 may cause the communications device 1100 to perform the method 900 described with respect to FIG. 9, or any aspect related to it; and the method 1000 described with respect to FIG. 10, or any aspect related to it.

Various components of the communications device 1100 may provide means for performing the method 900 described with respect to FIG. 9, or any aspect related to it; and the method 1000 described with respect to FIG. 10, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1146 and the antenna 1148 of the communications device 1100 in FIG. 11. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1146 and the antenna 1148 of the communications device 1100 in FIG. 11.

### Example Clauses

Implementation examples are described in the following numbered clauses:
Clause 1: A method for wireless communications at a user equipment (UE), comprising: measuring reference signals (RSs) associated with a set of beams; calculating, based on the measuring, first coefficients for combining a first subset of the set of beams to form a first adaptive beam; transmitting information regarding 1) the first coefficients, and 2) one or more identifier (IDs) associated with the first subset of beams; and processing, after transmitting the information, at least one transmission in accordance with the first adaptive beam.
Clause 2: The method of Clause 1, wherein the one or more IDs comprise synchronization signal block (SSB) IDs.
Clause 3: The method of any one of Clauses 1-2, further comprising selecting the first subset of beams based on the measuring.
Clause 4: The method of Clause 3, wherein the measuring comprises measuring at least one of signal to interference and noise ratio (SINR) or reference signal received power (RSRP).
Clause 5: The method of Clause 3, wherein: the measuring comprises measuring RSs from at least two different cells; and the first subset of beams comprises at least one beam from each of the at least two different cells.
Clause 6: The method of any one of Clauses 1-5, further comprising receiving signaling indicating at least one transmission configuration indicator (TCI) state associated with the first adaptive beam, wherein the processing is based on the TCI state.
Clause 7: The method of Clause 6, wherein the at least one TCI state comprises: a configured TCI state associated with adaptive beam weights; or a virtual TCI state with an index mapped to configured TCI states.
Clause 8: The method of any one of Clauses 1-7, wherein processing the at least one transmission comprises receiving a downlink transmission in accordance with the first adaptive beam.
Clause 9: The method of Clause 8, further comprising performing beam failure detection (BFD) based on the downlink transmission received in accordance with the first adaptive beam.
Clause 10: The method of Clause 9, wherein the BFD is based on a downlink (DL) RS transmitted according to the first coefficients.
Clause 11: The method of Clause 9, wherein the BFD is based on a combining, using the coefficients, of measurements of downlink (DL) RSs configured for the beams selected for the first subset.
Clause 12: The method of Clause 11, further comprising determining the DL RSs to measure and combined based on: an explicit configuration, or quasi co-location (QCL) source RSs associated with configured transmission configuration indicator (TCI) states.
Clause 13: The method of any one of Clauses 1-12, wherein processing the at least one transmission comprises transmitting an uplink transmission in accordance with the first adaptive beam.
Clause 14: The method of Clause 13, wherein processing the at least one transmission further comprises receiving a downlink transmission using beam weights corresponding to the first adaptive beam.
Clause 15: The method of Clause 13, wherein processing the at least one transmission further comprises receiving a downlink transmission using second coefficients corresponding to a second adaptive beam.
Clause 16: The method of Clause 15, further comprising transmitting information regarding the second coefficients.
Clause 17: A method for wireless communications at a network entity, comprising: transmitting reference signals (RSs) associated with a set of beams; receiving, from a user equipment (UE), information regarding 1) first coefficients for combining a first subset of the set of beams to form a first adaptive beam, and 2) one or more identifier (IDs) associated with the first subset of beams; and processing, after receiving the information, at least one transmission in accordance with the first adaptive beam.
Clause 18: The method of Clause 17, wherein the one or more IDs comprise synchronization signal block (SSB) IDs.
Clause 19: The method of any one of Clauses 17-18, wherein: the RSs are transmitted from at least two different cells associated with the network entity; and the first subset of beams comprises at least one beam from each of the at least two different cells.
Clause 20: The method of any one of Clauses 17-19, further comprising transmitting signaling indicating at least one transmission configuration indicator (TCI) state associated with the first adaptive beam, wherein the processing is based on the TCI state.
Clause 21: The method of Clause 20, wherein the at least one TCI state comprises: a configured TCI state associated with adaptive beam weights; or a virtual TCI state with an index mapped to configured TCI states.
Clause 22: The method of any one of Clauses 17-21, wherein processing the at least one transmission comprises transmitting, to the UE, a downlink transmission in accordance with the first adaptive beam.
Clause 23: The method of any one of Clauses 17-22, further comprising configuring the UE with downlink (DL) RSs for performing beam failure detection (BFD), wherein processing the at least one transmission comprises transmitting DL RSs in accordance with the configuration and the first adaptive beam.
Clause 24: The method of Clause 23, wherein the configuration: comprises an explicit configuration, or indicates quasi co-location (QCL) source RSs associated with configured transmission configuration indicator (TCI) states.
Clause 25: The method of any one of Clauses 17-24, wherein processing the at least one transmission comprises receiving, from the UE, an uplink transmission in accordance with the first adaptive beam.
Clause 26: The method of Clause 25, wherein processing the at least one transmission further comprises transmitting a downlink transmission using beam weights corresponding to the first adaptive beam.
Clause 27: The method of Clause 25, wherein processing the at least one transmission further comprises transmitting a downlink transmission using second coefficients corresponding to a second adaptive beam.
Clause 28: The method of Clause 27, further comprising receiving, from the UE, information regarding the second coefficients.
Clause 29: An apparatus, comprising: at least one memory comprising executable instructions; and at least one processor configured to execute the executable instructions and cause the apparatus to perform a method in accordance with any combination of Clauses 1-28.
Clause 30: An apparatus, comprising means for performing a method in accordance with any combination of Clauses 1-28.
Clause 31: A non-transitory computer-readable medium comprising executable instructions that, when executed by at least one processor of an apparatus, cause the apparatus to perform a method in accordance with any combination of Clauses 1-28.
Clause 32: A computer program product embodied on a computer-readable storage medium comprising code for performing a method in accordance with any combination of Clauses 1-28.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for measuring, means for calculating, means for transmitting, means for processing, means for selecting, means for receiving, means for performing, and means for configuring may comprise one or more processors, such as one or more of the processors described above with reference to FIG. 11.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
at least one memory comprising computer-executable instructions; and
one or more processors configured to execute the computer-executable instructions and cause the apparatus to:
measure reference signals (RSs) associated with a set of beams;
calculate, based on the measuring, a first set of coefficients for combining a first subset of the set of beams to form a first adaptive beam;
transmit information regarding 1) the first set of coefficients, and 2) one or more identifier (IDs) associated with the first subset of beams; and
process, after transmitting the information, at least one communications in accordance with the first adaptive beam.

2. The apparatus of claim 1, wherein the one or more IDs comprise synchronization signal block (SSB) IDs.

3. The apparatus of claim 1, wherein the one or more processors are further configured to cause the apparatus to:
select the first subset of beams based on the measuring.

4. The apparatus of claim 3, wherein the measuring comprises measuring at least one of signal to interference and noise ratio (SINR) or reference signal received power (RSRP).

5. The apparatus of claim 3, wherein the measuring comprises measuring RSs from at least two different cells; and the first subset of beams comprises at least one beam from each of the at least two different cells.

6. The apparatus of claim 1, wherein the one or more processors are further configured to cause the apparatus to:
receive signaling indicating at least one transmission configuration indicator (TCI) state associated with the first adaptive beam, wherein the processing is based on the TCI state.

7. The apparatus of claim 6, wherein the at least one TCI state comprises: a configured TCI state associated with adaptive beam weights; or a virtual TCI state with an index mapped to configured TCI states.

8. The apparatus of claim 1, wherein processing the at least one transmission comprises receiving a downlink transmission in accordance with the first adaptive beam.

9. The apparatus of claim 8, wherein the one or more processors are further configured to cause the apparatus to:
perform beam failure detection (BFD) based on the downlink transmission received in accordance with the first adaptive beam.

10. The apparatus of claim 9, wherein the BFD is based on a downlink (DL) RS transmitted according to the first coefficients.

11. The apparatus of claim 9, wherein the BFD is based on a combining, using the coefficients, of measurements of downlink (DL) RSs configured for the beams selected for the first subset.

12. The apparatus of claim 11, wherein the one or more processors are further configured to cause the apparatus to:
determine the DL RSs to measure and combined based on: an explicit configuration, or quasi co-location (QCL) source RSs associated with configured transmission configuration indicator (TCI) states.

13. The apparatus of claim 1, wherein processing the at least one transmission comprises transmitting an uplink transmission in accordance with the first adaptive beam.

14. The apparatus of claim 13, wherein processing the at least one transmission further comprises receiving a downlink transmission using beam weights corresponding to the first adaptive beam.

15. The apparatus of claim 13, wherein processing the at least one transmission further comprises receiving a downlink transmission using second coefficients corresponding to a second adaptive beam.

16. The apparatus of claim 15, wherein the one or more processors are further configured to cause the apparatus to:
transmit information regarding the second coefficients.

17. An apparatus for wireless communication, comprising:
at least one memory comprising computer-executable instructions; and
one or more processors configured to execute the computer-executable instructions and cause the apparatus to:
transmit reference signals (RSs) associated with a set of beams;
receive, from a user equipment (UE), information regarding 1) a first set of coefficients for combining a first subset of the set of beams to form a first adaptive beam, and 2) one or more identifier (IDs) associated with the first subset of beams; and
process, after receiving the information, at least one transmission in accordance with the first adaptive beam.

18. The apparatus of claim 17, wherein the one or more IDs comprise synchronization signal block (SSB) IDs.

19. The apparatus of claim 17, wherein the RSs are transmitted from at least two different cells associated with the network entity; and the first subset of beams comprises at least one beam from each of the at least two different cells.

20. A method for wireless communications at a user equipment (UE), comprising:
measuring reference signals (RSs) associated with a set of beams;
calculating, based on the measuring, a first set of coefficients for combining a first subset of the set of beams to form a first adaptive beam;
transmitting information regarding 1) the first set of coefficients, and 2) one or more identifier (IDs) associated with the first subset of beams; and
processing, after transmitting the information, at least one communications in accordance with the first adaptive beam.
